(19) United States
(12) Patent Application Publication
(10) Pub. No.: US 2015/0240028 A1
(43) Pub. Date: Aug. 27, 2015

(54) BIODEGRADABLE POLYMER COMPOUND

(71) Applicant: GUNZE LIMITED, Ayabe-shi (JP)

(72) Inventor: Hidetoshi Arimura, Ayabe-shi (JP)

(21) Appl. No.: 14/427,950

(22) PCT Filed: Aug. 14, 2013
(86) PCT No.: PCT/JP2013/071903

§ 371 Date: Mar. 12, 2015

(30) Foreign Application Priority Data
Oct. 18, 2012 (JP) 2012-230987

(51) Int. Cl. C08G 63/08

(52) U.S. Cl. CPC C08G 63/08

(57) ABSTRACT

The purpose of the present invention is to provide a biodegradable polymer compound that is pliable and displays the same decomposition behavior as linear lactic acid-ε-caprolactone copolymer. The problem is solved by a branched polymer (particularly, a star-shaped polymer) having at least three arms formed from lactic acid-ε-caprolactone copolymer and a weight-average molecular weight of at least 150,000.

### TECHNICAL FIELD

The present invention relates to a branched polymer having excellent flexibility and biodegradability/absorbability, and a method for producing the same.

### BACKGROUND ART

In order to promote healing of damaged dura maters, blood vessels, organs, etc., medical implants in a shape of sheet, film, patch, and the like made of a material capable of being degraded and absorbed in vivo (biodegradable material) are used. A medical implant made of a biodegradable material does not need to be removed after healing because even if it is applied to an affected part in vivo, it is degraded and absorbed after a certain period of time. This makes it possible to significantly reduce a burden on a patient. Such a medical implant is required to have dynamic properties similar equivalent to those of tissues or organs in a living body because it is retained in vivo for a long period of time. If a medical implant possesses dynamic properties different from those of tissues or the like of a living body, it will continue to give a physical stimulus to surrounding tissues or the like in contact therewith when being retained in vivo, and therefore it may induce damage or inflammation of the surrounding tissues. When a medical implant is used for compensating a dura mater or a blood vessel, several issues become concerning, such as generation of strain at an anastomosed part between the medical implant and the dura mater or the blood vessel in a living body or rupture of a sutured part due to difference in elasticity or flexibility from biological tissues. Thus, there has been expected development of a material that possesses flexibility equivalent to tissues or organs of a living body and that is rapidly degraded and absorbed after being retained in vivo for a certain period of time.

Examples of a resin capable of being degraded and absorbed in vivo include lactic acid-ε-caprolactone copolymers, and the copolymers are widely used in the medical field. Lactic acid-ε-caprolactone copolymers keep their initial molecular weight for a certain period of time in vivo and then are rapidly hydrolyzed and absorbed, and therefore, exhibit an excellent degradation behavior as a material for a medical implant. In order to control the flexibility of lactic acid-ε-caprolactone copolymers that are used as a material for a medical implant, a method of performing a ring-opening polymerization reaction while varying the polymerization temperature has hitherto been commonly used. For example, Patent Document 1 discloses a method for producing a lactic acid-ε-caprolactone copolymer while setting the reaction temperature at a temperature higher than 130° C. A lactic acid-ε-caprolactone copolymer obtained by such a method has been improved in flexibility, but it has been presently desired to be more improved in flexibility and elasticity as a material for a medical implant.

### PRIOR ART DOCUMENT

### Patent Document

Patent Document 1: Japanese Patent Laid-open Publication No. 2009-132769

### SUMMARY OF THE INVENTION

### Problems to be Solved by the Invention

A main object of the present invention is to provide a branched polymer having excellent flexibility and biodegradability/absorbability, and a method for producing the same.

### Means for Solving the Problem

The present inventor has studied earnestly in order to solve the above-described problem, and as a result, has found that a film made of a branched polymer (especially, a star-shaped polymer) having at least three arms formed from a lactic acid-ε-caprolactone copolymer and having a weight average molecular weight of 150,000 or more is excellent in flexibility and can have a property to be rapidly degraded and absorbed in vivo after a lapse of a certain period of time. The present invention has been completed by additional studies based on such findings.

That is, the present invention provides a biodegradable polymer compound and a method for producing the same with following aspects.

Item 1. A branched polymer comprising at least three arms formed from a lactic acid-ε-caprolactone copolymer and having a weight average molecular weight of 150,000 or more.
Item 2. The branched polymer according to Item 1, wherein the branched polymer is a star-shaped polymer comprising a core and at least three arms extending from the core and formed from a lactic acid-ε-caprolactone copolymer.
Item 3. The branched polymer according to Item 1 or 2, wherein the branched polymer is a star-shaped polymer comprising a pentaerythritol residue or a dipentaerythritol residue as the core, and having a structure in which a hydroxyl group of pentaerythritol or dipentaerythritol and a carboxyl group of the lactic acid-ε-caprolactone copolymer forming the arms are linked to each other by an ester bond.
Item 4. The branched polymer according to any one of Items 1 to 3, wherein the branched polymer is a compound represented by a following general formula (1) or (2):

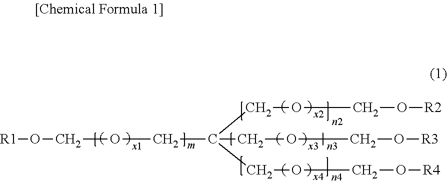

in the general formula (1), n1 to n4 are the same or different and each represent an integer of 0 to 4, x1 to x4 are the same or different and each represent 0 or 1, R1 to R4 are the same or different and each represent a lactic acid-ε-caprolactone copolymer or a hydrogen atom, and at least three of R1 to R4 represent a lactic acid-ε-caprolactone copolymer,

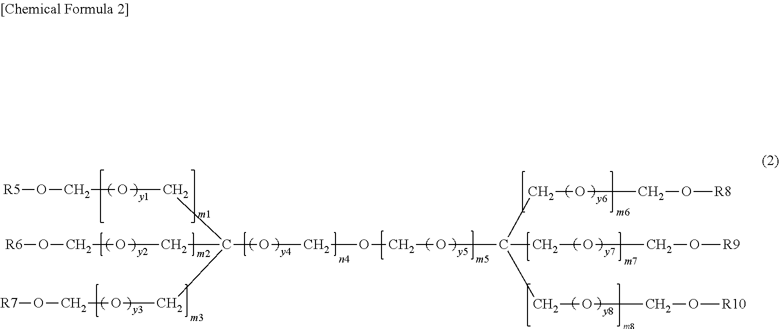

in the general formula (2), m1 to m8 are the same or different and each represent an integer of 0 to 4, y1 to y8 are the same or different and each represent 0 or 1, R5 to R10 are the same or different and each represent a lactic acid-ε-caprolactone copolymer or a hydrogen atom, and at least three of R5 to R10 represent a lactic acid-ε-caprolactone copolymer.
Item 5. A branched polymer, obtained by performing ring-opening polymerization of lactide and ε-caprolactone in the presence of a trihydric or more polyhydric alcohol at a reaction temperature of 130° C. or lower, the branched polymer comprising at least three arms formed from a lactic acid-ε-caprolactone copolymer and having a weight average molecular weight of 150,000 or more.
Item 6. A medical material comprising the branched polymer according to any one of Items 1 to 5.
Item 7. The medical material according to Item 6, wherein the medical material is at least one medical implant selected from the group consisting of an artificial dura mater, an artificial blood vessel, a cartilage matrix, and an anti-adhesion membrane.
Item 8. A method for producing a branched polymer comprising at least three arms formed from a lactic acid-ε-caprolactone copolymer and having a weight average molecular weight of 150,000 or more, the production method comprising a step of:

performing ring-opening polymerization of lactide and ε-caprolactone in the presence of a trihydric or more polyhydric alcohol, wherein

a reaction temperature is 130° C. or lower.

Item 9. Use of the branched polymer according to any one of Items 1 to 5 for production of a medical material.
Item 10. A method for treating a patient having a disease for which transplantation of a medical implant is required, the treating method comprising a step of inserting a medical implant comprising the branched polymer according to any one of Items 1 to 5 into a site affected by the disease.

### Advantages of the Invention

The branched polymer of the present invention has excellent flexibility as well as degradability and absorbability in vivo. Especially, the branched polymer of the present invention has excellent flexibility which cannot be attained by conventional biodegradable polymer compounds, while keeping a degradation behavior in vivo similar to that of a linear lactic acid-ε-caprolactone copolymer that has hitherto been commonly used as a medical material, and therefore, it is particularly suitable as a material for medical implants requiring flexibility, such as an artificial dura mater and an artificial blood vessel. Moreover, the production method of the present invention can efficiently prepare a branched polymer having the above-mentioned properties.

### MODE FOR CARRYING OUT THE INVENTION

### 1. Branched Polymer

The branched polymer of the present invention has a branched structure comprising three arms formed from a lactic acid-ε-caprolactone copolymer. In the branched polymer, the number of the arms formed from the lactic acid-ε-caprolactone copolymer may be any number of 3 or more, preferably 3 to 10, more preferably 4 to 8, particularly preferably 4 to 6.

In the lactic acid-ε-caprolactone copolymer that forms the arms of the branched polymer of the present invention, the lactic acid may be any one of L-lactic acid, D-lactic acid, and a mixture of L-lactic acid and D-lactic acid, but preferred is L-lactic acid. The lactic acid-ε-caprolactone copolymer that forms the arms may be any one of an alternating copolymer, a block copolymer, and a random copolymer, but preferred is a random copolymer.

In the branched polymer of the present invention, the molar ratio of lactic acid/ε-caprolactone in the lactic acid-ε-caprolactone copolymer that forms the arms is, for example, 35/65 to 65/35, preferably 40/60 to 60/40, more preferably 45/55 to 55/45. The three or more arms in the branched polymer of the present invention may be formed from lactic acid-ε-caprolactone copolymers each having the same composition or alternatively may be formed from lactic acid-ε-caprolactone copolymers each having different composition.

In the branched polymer of the present invention, the weight average molecular weight per one molecule of the lactic acid-ε-caprolactone copolymer that forms the arms is not particularly limited as long as it can fulfill the below-described weight average molecular weight of the entire branched polymer, but it is, for example, 30,000 to 100,000, preferably 31,000 to 90,000, more preferably 32,000 to 75,000. Herein, the weight average molecular weight is a value measured by gel permeation chromatography using a linear polystyrene standard. The three or more arms in the branched polymer of the present invention may each have the same weight average molecular weight or alternatively may each have different weight average molecular weight.

The branched polymer of the present invention has a weight average molecular weight of 150,000 or more, preferably 160,000 to 500,000, more preferably 190,000 to 450,000. Herein, the weight average molecular weight is a value measured by gel permeation chromatography using a linear polystyrene standard (GPC: specific conditions are described in Examples below). By adjusting the weight average molecular weight of the branched polymer to the above range, it is possible to secure more improved flexibility or biodegradability/absorbability when the branched polymer is used as a material for medical implants such as an artificial dura mater and an artificial blood vessel.

The structure of the branched polymer of the present invention is not particularly limited as long as the polymer is a branched polymer comprising three or more arms formed from a lactic acid-ε-caprolactone copolymer, wherein the arms are linked to a core. The structure may be any shape, e.g., a star shape, a comb shape, an H shape, a bottle-brush shape, or a star-burst shape. From the viewpoint of more favorably imparting high flexibility and excellent biodegradability/absorbability, a star-shaped polymer is preferred as the structure of the branched polymer of the present invention.

The structure of the core in the branched polymer of the present invention is not particularly limited and may be appropriately designed depending on the structure of the branched polymer. Examples of the core in the branched polymer include a residue of a trihydric or more polyhydric alcohol and a residue of a trivalent or more polyvalent amine. When the core in the branched polymer is formed from a residue of a trihydric or more polyhydric alcohol, the core has a structure in which a hydroxyl group of the polyhydric alcohol is linked to a carboxyl group of the lactic acid-ε-caprolactone copolymer forming the arms by an ester bond. When the core in the branched polymer is formed from a residue of a trivalent or more polyvalent amine, the core has a structure in which an amino group of the polyvalent amine is linked to a carboxyl group of the lactic acid-ε-caprolactone copolymer forming the arms by an amide bond.

Specific examples of the compound forming the core in the branched polymer include trihydric or more polyhydric alcohols such as pentaerythritol, dipentaerythritol, tripentaerythritol, glycerin, diglycerin, triglycerin, sorbitol, poly(vinyl alcohol), poly(hydroxyethyl methacrylate), and poly(hydroxypropyl methacrylate); monosaccharides such as glucose, galactose, mannose, and fructose; and disaccharides such as lactose, sucrose, and maltose. Specific examples of the trivalent or more polyvalent amine include triethylenetetramine, polyoxyethylenetriamine, diethylenetriamine, tetraethylenepentamine, pentaethylenehexamine, and triaminopropane.

A preferable example of the branched polymer of the present invention includes a star-shaped polymer having a pentaerythritol residue or a dipentaerythritol residue as a core, namely, a star-shaped polymer which is obtained by performing ring-opening polymerization of lactide and ε-caprolactone using each hydroxyl group of pentaerythritol or dipentaerythritol as a polymerization initiation point and which has a structure in which a carboxyl group of a lactic acid-ε-caprolactone copolymer forming arms is linked to a hydroxyl group of a core by an ester bond.

Preferable examples of the branched polymer include star-shaped polymers represented by the following general formulas (1) and (2).

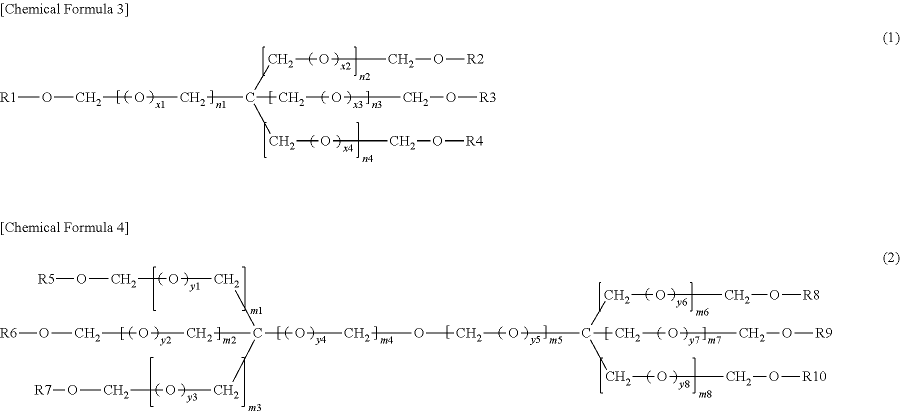

In the general formula (1), n1 to n4 are the same or different and each represent an integer of 0 to 4. n1 to n4 each preferably represent an integer of 0 to 2, more preferably 0.

In the general formula (1), x1 to x4 are the same or different and each represent 0 or 1. x1 to x4 each preferably represent 0.

Moreover, in the general formula (1), R1 to R4 are the same or different and each represent a lactic acid-ε-caprolactone copolymer or a hydrogen atom, and at least three of R1 to R4 represent a lactic acid-ε-caprolactone copolymer. Preferable examples of the star-shaped polymer represented by the general formula (1) include polymers in which all of R1 to R4 are lactic acid-ε-caprolactone copolymers. The at least three lactic acid-ε-caprolactone copolymers forming R1 to R4 may each have the same molecular weight or alternatively may each have a different molecular weight. As to the at least three lactic acid-ε-caprolactone copolymers forming R1 to R4, the molecular weights thereof, the kind of an optical isomer of the lactic acid that is a constituent of each of the copolymers, and so on are as described above. The lactic acid-ε-caprolactone copolymers forming R1 to R4 are linked by forming ester bonds together with oxygen atoms in the general formula (1).

In the general formula (2), m1 to m8 are the same or different and each represent an integer of 0 to 4. m1 to m3 and m6 to m8 each preferably represent an integer of 0 to 2, and more preferably represent 0. m4 and m5 each preferably represent an integer of 1 to 3, and more preferably represent 1.

In the general formula (2), y1 to y8 are the same or different and each represent 0 or 1. y1 to y8 each preferably represent 0.

Moreover, in the general formula (2), R5 to R10 are the same or different and each represent a lactic acid-ε-caprolactone copolymer or a hydrogen atom, and at least three of R5 to R10 represent a lactic acid-ε-caprolactone copolymer. The star-shaped polymer represented by the general formula (1) is preferably a polymer in which at least four of R5 to R10 are lactic acid-ε-caprolactone copolymers, more preferably a polymer in which at least five of R5 to R10 are lactic acid-ε-caprolactone copolymers, and particularly preferably a polymer in which all of R5 to R10 are lactic acid-ε-caprolactone copolymers. The at least three lactic acid-ε-caprolactone copolymers forming R5 to R10 may each have the same molecular weight or alternatively may each have a different molecular weight. As to the at least three lactic acid-ε-caprolactone copolymers forming R5 to R10, the molecular weights thereof, the kind of an optical isomer of the lactic acid that is a constituent of each of the copolymers, and so on are as described above. The lactic acid-ε-caprolactone copolymers forming R5 to R10 are linked by forming ester bonds together with oxygen atoms in the general formula (1).

### 2. Production Method

The branched polymer of the present invention can be prepared, when a trihydric or more polyhydric alcohol is used as a core, by ring-opening polymerization of lactide and ε-caprolactone utilizing each hydroxyl group of the compound for forming the core as a polymerization initiation point. When a trivalent or more polyvalent amine is used as a core, the branched polymer may be also prepared by preparing a lactic acid-ε-caprolactone copolymer having a reactive functional group such as a carboxyl group at its one end beforehand, and then bonding the reactive functional group to a hydroxyl group or amino group of the compound for forming the core by a coupling reaction. In the present invention, the method of preparing the branched polymer by ring-opening polymerization is preferable because of its high reaction efficiency.

The method of preparing a branched polymer by ring-opening polymerization of lactide and ε-caprolactone includes a method comprising a step of performing ring-opening polymerization of lactide and ε-caprolactone in the presence of a trihydric or more polyhydric alcohol, wherein the reaction temperature is 130° C. or lower. The particulars of the lactic acid-ε-caprolactone copolymer and the trihydric or more polyhydric alcohol are as described above.

When lactide and ε-caprolactone are subjected to ring-opening polymerization, a conventionally known catalyst may be used. Examples of the catalyst to be used for the ring-opening polymerization of lactide and ε-caprolactone include metal catalysts such as tin 2-ethylhexanoate, tin(II) octylate, triphenyltin acetate, tin oxide, dibutyltin oxide, tin oxalate, tin chloride, dibutyltin dilaurate, thorium ethoxide, potassium tert-butoxide, triethyl aluminum, tetrabutyl titanate, and bismuth; and organic base catalysts such as organic onium salts. Among them, metal catalysts containing tin are preferable, and more specifically, tin 2-ethylhexanoate is a preferable example.

When the catalyst is used in the production method of the present invention, the use amount thereof is not particularly limited as long as it is such an amount that the ring-opening polymerization reaction of lactic acid and ε-caprolactone can be catalyzed; in the case of a metal catalyst, the amount thereof is 30 to 150 ppm in terms of metal, and more specifically, when tin 2-ethylhexanoate is used, the amount thereof is 50 to 130 ppm, preferably 70 to 110 ppm in terms of tin. In the case of an organic base catalyst, the amount thereof is for example 0.1 to 2.0 mol % based on the monomers.

In the method for producing a branched polymer of the present invention, the reaction temperature at the time of performing ring-opening polymerization is 130° C. or lower, preferably 90 to 130° C., more preferably 120 to 130° C. By performing the reaction under such temperature conditions, it is possible to prepare a branched polymer having a moderate weight average molecular weight and flexibility. The atmosphere for the ring-opening polymerization is not particularly limited, and the polymerization may be performed either under reduced pressure or vacuum, or alternatively may be performed in an atmosphere of inert gas such as nitrogen gas or argon gas.

In the production method of the present invention, a branched polymer prepared may be, as necessary, further subjected to treatment such as pulverization, purification, washing, or drying in accordance with a conventionally known method.

When a metal catalyst is used as the catalyst to be used in performing the ring-opening polymerization reaction of lactic acid and ε-caprolactone, it is preferable to use a washing solvent capable of removing the catalyst. As such a washing solvent, a washing solvent composed of an organic acid and an alcohol can be suitably used, and a specific example thereof includes a mixture of acetic acid and isopropanol. The mixing ratio of acetic acid with isopropanol may be any ratio as long as the branched polymer does not dissolve, and preferably, the mixing ratio of acetic acid/isopropanol is 15/85 to 35/65 (volume/volume). The amount of the washing solvent should be 1 L or more per kg of the branched polymer, and preferably 1 L to 5 L. As to the number of replacement of the washing liquid, the liquid should be replaced until the metal catalyst remains less than 1 ppm, and for example, the replacement is performed at 5 times to 10 times.

### 3. Application and Property

The branched polymer of the present invention has excellent biodegradability/absorbability similar to those of conventional linear lactic acid-ε-caprolactone copolymers and also has flexibility equivalent to that of a biological tissue or the like. Therefore, such a biodegradable polymer compound is suitably utilized as a medical material. That is, the present invention provides a medical material comprising the biodegradable polymer compound, especially a medical implant.

The medical material comprising the branched polymer of the present invention may be composed exclusively of the branched polymer, but may contain other biodegradable/absorbable polymers, as necessary. Examples of the other biodegradable/absorbable polymers include polylactic acid, lactic acid-glycolic acid copolymers, polyglycolic acid, lactic acid-ε-caprolactone copolymers, glycolic acid-ε-caprolactone copolymers, lactic acid-glycolic acid-ε-caprolactone terpolymers, and polydioxanone.

When the medical material comprising the branched polymer of the present invention contains a biodegradable/absorbable polymer other than the branched polymer, the content of the biodegradable/absorbable polymer is not particularly limited, but for example, the content of the biodegradable/absorbable polymer (other than the branched polymer) is 0 to 90 parts by weight, preferably 0 to 70 parts by weight, and more preferably 0 to 50 parts by weight, based on 100 parts by weight of the medical material.

The shape of the medical material comprising the branched polymer of the present invention is not particularly limited, and examples thereof include a sheet, a film, a patch, a tube, a foam, a fibrous structure, and a meshed plate. The medical material may, as necessary, contain a cell growth factor, a growth factor, an antibacterial agent, an antibiotic substance, or the like, or alternatively may be surface-coated with such a substance. A preferred embodiment of the medical material is, for example, a medical implant. Specific examples of the medical implant include an artificial dura mater, an artificial blood vessel, a cartilage matrix, and an anti-adhesion membrane, and among these, especially an artificial dura mater and an artificial blood vessel are required to have excellent flexibility, so that the branched polymer of the present invention is suitably used therefor. That is, for a patient having a disease for which transplantation or insertion of an artificial dura mater, an artificial blood vessel, a cartilage matrix, an anti-adhesion membrane or the like is required, a medical implant formed using the branched polymer of the present invention is used by insertion into a site affected by the disease.

The preparation of the medical material can be performed using the branched polymer of the present invention as a starting material by a publicly known method commonly used in the technical field. For example, in the case of a film-like medical material, it can be obtained by dissolving the branched polymer and the optional other biodegradable/absorbable polymers in a known solvent to form a polymer solution, and casting the solution, followed by drying. The film may be obtained by melt-molding processing. In the case of a tube-like medical material, it may be obtained by dissolving the branched polymer and the optional other biodegradable/absorbable polymers in a known solvent to form a polymer solution, and casting the solution into a mold, followed by drying with a known method such as air dry or freeze dry, or may be obtained by melt-molding processing.

The medical material comprising the branched polymer of the present invention has excellent flexibility, and therefore there is no need of concerning damage of surrounding tissues, rupture of anastomosed part formed with biological tissues, or the like even when the medical material is retained in vivo for a long period of time. The flexibility of the medical material comprising the branched polymer of the present invention varies depending on the amount of the other biodegradable/absorbable polymers to be contained, but an initial elastic modulus in the case of a cast film (100 μm in thickness, 80 mm×10 mm) made exclusively of the branched polymer of the present invention is 10 to 70 MPa, preferably 20 to 60 MPa. The stress at the maximum point as measured under the same conditions is 5 to 40 MPa, preferably 10 to 30 MPa. Herein, the flexibility of the medical material can be evaluated under conditions of an inter-chuck distance of 15 mm and a tensile rate of 10 mm/minute by using a universal tensile tester (EZ-Graph, manufactured by Shimadzu Corporation).

The medical material prepared by using the branched polymer of the present invention as a material includes a property such that the medical material is rapidly degraded after being embedded in vivo and a certain period of time elapses. The degradation properties possessed by the medical material vary depending on the amount of the other biodegradable/absorbable polymers to be contained, but in the case of a medical material made exclusively of the branched polymer of the present invention, the molecular weight remaining ratio after immersion in a phosphate buffer (PBS(−), pH 7.4) at 37° C. for 30 days is usually 70% or less, preferably 0 to 60%, more preferably 0 to 55%. Herein, the molecular weight remaining ratio is a value calculated in accordance with the following formula.

Molecular weight remaining ratio (%)={weight average molecular weight of polymer constituting medical material after immersion in PBS(−)/weight average molecular weight of polymer constituting medical material before immersion in PBS(−)}×100 [Numeral Formula 1]

### EXAMPLES

Hereafter, the present invention will be described in more detail based on synthesis examples, test examples, and so on, but the present invention is not limited thereby.

### Synthesis Example 1

334.8 g (2.325 mol) of L-lactide, 257.4 g (2.325 mol) of ε-caprolactone, 300 ppm of tin 2-ethylhexanoate, and 500 ppm of pentaerythritol were placed in a separable flask and were dried under reduced pressure, and then polymerized at 130° C. for 7 days in a nitrogen atmosphere. The resulting lactic acid-ε-caprolactone copolymer (hereinafter referred to as PE-500) was pulverized with a rotary pulverizer having a mesh size of 3 mm, and then was subjected to washing treatment with a mixed solvent of acetic acid/isopropanol (volume ratio: 20/80) (washing nine times at a rate of 500 ml of the mixed solvent to 100 g of the branched polymer), affording a branched polymer PE-500.

In Synthesis Example 1, L-lactide, ε-caprolactone, and pentaerythritol were charged so that the number average molecular weight per one arm of the resulting branched polymer would theoretically be 67800. For the resulting branched polymer (PE-500), the weight average molecular weight thereof was measured by GPC (solvent: chloroform, flow rate: 1 ml/minute, a linear polystyrene standard was used). As a result, the branched polymer (PE-500) obtained in Synthesis Example 1 had a weight average molecular weight of 220,000.

### Synthesis Example 2

334.8 g (2.325 mol) of L-lactide, 257.4 g (2.325 mol) of ε-caprolactone, 300 ppm of tin 2-ethylhexanoate, and 500 ppm of dipentaerythritol were placed in a separable flask and were dried under reduced pressure, and then polymerized at 130° C. for 7 days in a nitrogen atmosphere. The resulting lactic acid-ε-caprolactone copolymer (hereinafter referred to as DPE-500) was pulverized with a rotary pulverizer having a mesh size of 3 mm, and then was subjected to washing treatment with an acetic acid/isopropanol mixed solvent in the same manner as in Synthesis Example 1, affording a branched polymer DPE-500.

In Synthesis Example 2, L-lactide, ε-caprolactone, and pentaerythritol were charged so that the number average molecular weight per one arm of the resulting branched polymer would theoretically be 84500. For the resulting branched polymer DPE-500, analysis by GPC was performed under the same conditions as in Synthesis Example 1. As a result, the branched polymer (DPE-500) obtained in Synthesis Example 2 had a weight average molecular weight of 200,000.

### Comparative Synthesis Example 1

334.8 g (2.325 mol) of L-lactide, 257.4 g (2.325 mol) of ε-caprolactone, and 300 ppm of tin 2-ethylhexanoate were placed in a separable flask and were dried under reduced pressure, and then polymerized at 130° C. for 7 days in a nitrogen atmosphere. The resulting lactic acid-ε-caprolactone copolymer (hereinafter referred to as PLCL) was pulverized with a rotary pulverizer having a mesh size of 3 mm, and then was subjected to washing treatment with an acetic acid/isopropanol mixed solvent in the same manner as in Synthesis Example 1, affording a linear polymer PLCL.

For the resulting linear polymer PLCL, analysis by GPC was performed under the same conditions as in Synthesis Example 1. As a result, the linear polymer PLCL obtained in Comparative Synthesis Example 1 had a weight average molecular weight of 170,000.

### [Preparation of Cast Film]

Using the polymers obtained in Synthesis Example 1, Synthesis Example 2, and Comparative Synthesis Example 1, 1,4-dioxane solutions containing each of the polymers in a proportion of 4% by weight were prepared. Each of the solutions was cast on a horizontal table and then subjected to air-drying in draft at 20° C. for 24 hours. Eventually, cast films each having a thickness of about 100 μm were obtained.

### [Tensile Test]

Each of the cast films obtained above was cut into a strip sized 80 mm×10 mm and then its initial elastic modulus was measured, so that the flexibility of the cast film was evaluated. The flexibility was evaluated using initial elastic modulus between 0.5N and 1.5N. For the same cast film, a stress at the maximum point was measured and the strength was evaluated. It is indicated that a material having a lower initial modulus and a larger stress at the maximum point is more flexible and less likely to rupture. The tensile strength was measured under conditions of an inter-chuck distance of 15 mm and a tensile rate of 10 mm/minute by using a universal tensile tester (EZ-Graph, manufactured by Shimadzu Corporation). The results are given in Table 1 below.

TABLE 1

| | Initial elastic | Stress at maximum |
|---|---|---|
| | modulus (MPa) | point (MPa) |
| Synthesis Example 1 | 33 | 27 |
| Synthesis Example 2 | 63 | 23 |
| Comparative | 72 | 31 |
| Synthesis Example 1 | | |

As shown in Table 1, the branched polymers obtained in Synthesis Examples 1 and 2 were shown to have excellent flexibility. Especially, the initial elastic modulus of Synthesis Example 1 was low as compared with that of Comparative Synthesis Example 1, and it was shown that a branched polymer having a pentaerythritol residue as a core is more superior in flexibility. On the other hand, both Synthesis Examples 1 and 2 were almost the same as Comparative Synthesis Example 1 in stress at the maximum point, and were comparable in mechanical strength. That is, Synthesis Example 1 was shown to maintain mechanical strength while being flexible as compared with Comparative Synthesis Example 1.

### [Hydrolysis Test]

Each of the cast films obtained using the polymers obtained in Synthesis Example 1, Synthesis Example 2, and Comparative Synthesis Example 1 was cut into a strip sized 80 mm×10 mm and then was immersed in PBS(−) (ph7.4) at 37° C. for 1, 2, 4, or 8 week(s). After a lapse of a predetermined period of time, the weight average molecular weight was measured by GPC and the rate of decrease in the weight average molecular weight of the polymer after the immersion relative to the initial weight average molecular weight was calculated as a decrease rate (%) of the molecular weight of the polymer, so that hydrolyzability was evaluated. The results are given in Table 2 below.

As shown in Table 2, the cast films prepared from the branched polymers obtained in Synthesis Examples 1 and 2 exhibited degradation behavior similar to that of the linear PLCL of Comparative Synthesis Example 1, and it was shown that the films were usable for applications similar to those of conventionally used medical materials comprising linear PLCL as a constituent.

TABLE 2

| Molecular weight | | | | | |
|---|---|---|---|---|---|
| remaining ratio | Initial | 1 week | 2 weeks | 4 weeks | 8 weeks |
| Synthesis | 100% | 83% | 80% | 57% | 28% |
| Example 1 | | | | | |
| Synthesis | 100% | 81% | 77% | 52% | 23% |
| Example 2 | | | | | |
| Comparative | 100% | 75% | 65% | 44% | 23% |
| Synthesis | | | | | |
| Example 1 | | | | | |

According to these results, it was confirmed that the cast films prepared using the biodegradable polymer compounds obtained in Synthesis Examples 1 and 2 each include a high initial elastic modulus and a property to be rapidly degraded after a lapse of a certain period of time and are particularly suitably usable as a material for medical implants requiring flexibility, such as an artificial dura mater and an artificial blood vessel.

1. A branched polymer comprising at least three arms formed from a lactic acid-ε-caprolactone copolymer and having a weight average molecular weight of 150,000 or more.

2. The branched polymer according to claim 1, wherein the branched polymer is a star-shaped polymer comprising a core and at least three arms extending from the core and formed from a lactic acid-ε-caprolactone copolymer.

3. The branched polymer according to claim 1, wherein the branched polymer is a star-shaped polymer comprising a pentaerythritol residue or a dipentaerythritol residue as the core, and having a structure in which a hydroxyl group of pentaerythritol or dipentaerythritol and a carboxyl group of the lactic acid-ε-caprolactone copolymer forming the arms are linked to each other by an ester bond.

4. The branched polymer according to claim 1, wherein the branched polymer is a compound represented by a following general formula (1) or (2): 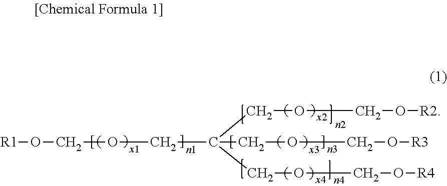
wherein, in general formula (1), n1 to n4 are the same or different and each represent an integer of 0 to 4, x1 to x4 are the same or different and each represent 0 or 1, R1 to R4 are the same or different and each represent a lactic acid-ε-caprolactone copolymer or a hydrogen atom, and at least three of R1 to R4 represent a lactic acid-ε-caprolactone copolymer, 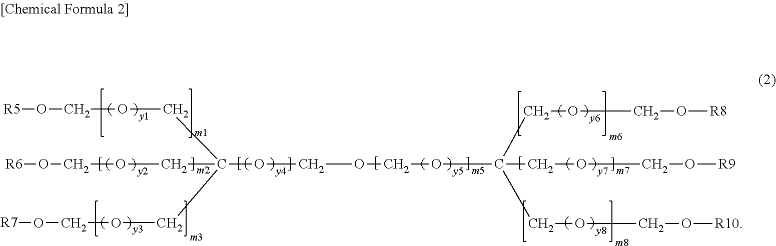
wherein, in the general formula (2), m1 to m8 are the same or different and each represent an integer of 0 to 4, y1 to y8 are the same or different and each represent 0 or 1, R5 to R10 are the same or different and each represent a lactic acid-s-caprolactone copolymer or a hydrogen atom, and at least three of R5 to R10 represent a lactic acid-s-caprolactone copolymer.

5. A branched polymer, obtained by performing ring-opening polymerization of lactide and ε-caprolactone in the presence of a trihydric or more polyhydric alcohol at a reaction temperature of 130° C. or lower, the branched polymer comprising at least three arms formed from a lactic acid-ε-caprolactone copolymer and having a weight average molecular weight of 150,000 or more.

6. A medical material comprising the branched polymer according to claim 1.

7. The medical material according to claim 6, wherein the medical material is at least one medical implant selected from the group consisting of an artificial dura mater, an artificial blood vessel, a cartilage matrix, and an anti-adhesion membrane.

8. A method for producing a branched polymer comprising at least three arms formed from a lactic acid-ε-caprolactone copolymer and having a weight average molecular weight of 150,000 or more, the production method comprising a step of:
performing ring-opening polymerization of lactide and ε-caprolactone in the presence of a trihydric or more polyhydric alcohol, at a reaction temperature of 130° C. or lower.

9. (canceled)

10. A method for treating a patient having a disease for which transplantation of a medical implant is required, the treating method comprising a step of inserting a medical implant comprising the branched polymer according to claim 1 into a site affected by the disease.
